(19) United States
(12) Patent Application Publication
(10) Pub. No.: US 2022/0041904 A1
(43) Pub. Date: Feb. 10, 2022

(54) Auto Body Double Sided Masking Tape

(71) Applicant: Franklin Smith, JR., Brooklyn, NY (US)

(72) Inventor: Franklin Smith, JR., Brooklyn, NY (US)

(21) Appl. No.: 16/890,230

(22) Filed: Aug. 8, 2020

(51) Int. Cl. C09J 9/00

(52) U.S. Cl. CPC C09J 9/00; C09J 2301/1242

(57) ABSTRACT

A double sided adhesive masking Tape used for several applications involving Auto Body painting. This tape can be used from the preparation of the vehicle which includes priming, to the final stage which is the complete paint job.

### BACKGROUND OF INVENTION

This invention relates to Auto body repair. This Auto body double sided masking tape simplifies preparation and painting procedures. The use of this tape would minimize time and material. For example, while using this Auto body double sided masking tape all you have to do is lay your tape, peel your release paper and stick your choice of plastic or paper. On the other hand when using a single sided regular masking tape you will have to lay your tape, paper and then tape again to hold down your paper/plastic. So by using this double sided Auto body masking tape it simplifies and reduces material and labor.

### BRIEF SUMMARY OF INVENTION

This is a double-sided Auto body Masking Tape that is used to make the preparing and painting vehicles stage easier in the AutoMotive industry. With this tape design it reduces preparation time as well as the amount of material being used by Auto body shops.

### DETAIL DESCRIPTION

This Auto Body Masking Tape is a 3 part tape that consists of an outer layer which is the release paper/Film, the middle layer which is one side of the double sided tape and last you have the inner layer or the last layer which is the part that sticks to your vehicle or your selected surface of choice.

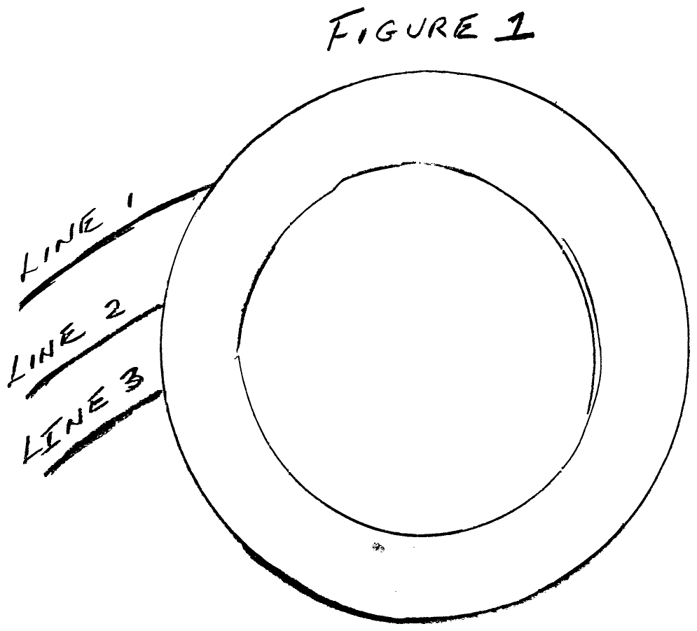

### FIG. 1 Description

Line 1: Release Paper

Line 2: Top Adhesive

Line 3: Bottom Adhesive

What I claim is:

1: A double sided Auto Body Masking Tape comprising 3 parts, the Outer surface referred to as the film or release paper, the second Part under the film is one part of the adhesive tape, the final part is the bottom part which is also adhesive which is the section that adheres to give your surface which makes a double-sided masking tape

2: The double sided Auto Body masking tape of claim 1 further comprising: different colors, red, blue, white, yellow, orange, purple, black, green, etc.

3: The double-sided Auto Body masking tape of claim 2 further comprising: different sizes ranging from 1-4 inches in width and 50-60 yards in length.
